(19) United States
(12) Patent Application Publication
(10) Pub. No.: US 2024/0217731 A1
(43) Pub. Date: Jul. 4, 2024

(54) SERVICE LIFT FOR A REFUSE VEHICLE

(71) Applicant: Oshkosh Corporation, Oshkosh, WI (US)

(72) Inventors: Vince Schad, Oshkosh, WI (US); Nicholas Weykamp, Oshkosh, WI (US); Derek A. Wente, Austin, MN (US); Martin J. Schimke, Red Granite, WI (US); Bennett Unfried, Oshkosh, WI (US); Jerrod Kappers, Oshkosh, WI (US)

(21) Appl. No.: 18/399,488

(22) Filed: Dec. 28, 2023

Related U.S. Application Data
(60) Provisional application No. 63/435,975, filed on Dec. 29, 2022.

(51) Int. Cl. B65F 3/02

(52) U.S. Cl. CPC B65F 3/02; B65F 2003/0279

(57) ABSTRACT

Systems and methods provided herein relate to a vehicle including a chassis. The chassis includes a pair of longitudinal frame rails. The vehicle further includes a body and a scissor lift disposed between the chassis and the body and between the pair of longitudinal frame rails, the scissor lift configured to lift the body relative to the chassis. The vehicle further includes a pivot mount pivotally coupling the body to the chassis such that the body is rotatable about an axis of rotation extending laterally when the body is lifted relative to the chassis, such that the body is rotatable from a first position wherein the body is supported by the chassis and a second position wherein at least a portion of the body is lifted above the chassis.

### CROSS-REFERENCE TO RELATED PATENT APPLICATIONS

The present application claims the benefit of and priority to U.S. Provisional Application No. 63/435,975, filed Dec. 29, 2022, the entire disclosure of which is hereby incorporated by reference herein.

### BACKGROUND

Refuse vehicles collect a wide variety of waste, trash, and other material from residences and businesses. Operators of the refuse vehicles transport the material in the refuse vehicle from various waste receptacles within a municipality to a storage or processing facility (e.g., a landfill, an incineration facility, a recycling facility, etc.).

### SUMMARY

One embodiment of the present disclosure relates to a refuse vehicle. The refuse vehicle includes a chassis, a body coupled to the chassis, and a service lift. The chassis includes a pair of frame rails. The body includes a lift assembly configured to place refuse material into the body. The service lift is configured to lift the body away from the chassis. The service lift is disposed between the chassis and the body and laterally between the pair of frame rails.

Another embodiment of the present disclosure relates to a refuse vehicle. The refuse vehicle includes a chassis, body coupled to the chassis, and a service lift. The chassis includes a pair of frame rails. The body includes a lift assembly configured to place refuse material into the body. The service lift is configured to lift at a portion of the body away from the chassis. At least a portion of the service lift is disposed within the body.

Yet another embodiment of the present disclosure relates to a method of installing a service lift onto a refuse vehicle. The method includes mounting a first end of the service lift to a chassis of the refuse vehicle so that the first end is disposed laterally between a pair of frame rails to the chassis. The method also includes mounting a second end of the service lift to a body of the refuse vehicle so that the service lift is disposed between the chassis and the body.

Another embodiment of the present disclosure relates to a vehicle including a chassis. The chassis includes a pair of longitudinal frame rails. The vehicle further includes a body and a scissor lift disposed between the chassis and the body and between the pair of longitudinal frame rails, the scissor lift configured to lift the body relative to the chassis. The scissor lift may be powered by an electric motor, an air bag, or another type of driver. The vehicle further includes a pivot mount pivotally coupling the body to the chassis such that the body is rotatable about an axis of rotation extending laterally when the body is lifted relative to the chassis, such that the body is rotatable from a first position in which the body is supported by the chassis and a second position in which at least a portion of the body is lifted above or otherwise separated from the chassis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a refuse vehicle, according to an embodiment.

FIG. 2A is a side view of a refuse vehicle with a lifted body, according to an embodiment.

FIG. 2B is a front view of a service lift that is mounted to a platform and in a lifted position, according to an embodiment.

FIG. 3A is a front view of a service lift in a lifted position, according to an embodiment.

FIG. 3B is a side view of a refuse vehicle that includes a service lift, according to an embodiment.

FIG. 4 is a side view of the service lift of FIG. 2A, according to an embodiment.

FIG. 5 is a side view of a refuse vehicle that includes a service lift, according to another embodiment.

FIG. 6 is a front view of a service lift assembly, according to an embodiment.

FIG. 7 is a side view of a refuse vehicle that includes a service lift, according to another embodiment.

FIG. 8 is a front view of a service lift assembly, according to another embodiment.

FIG. 9 is a side view of a refuse vehicle that includes a service lift, according to another embodiment.

FIG. 10 is a side view of the refuse vehicle that includes a service lift, according to another embodiment.

FIG. 11 is a partial side view of a service lift assembly in a retracted position, according to an embodiment.

FIG. 12 is a rear view of a cross bar pivot system for a refuse vehicle, according to an embodiment.

FIG. 13 is a flow diagram of a method of installing a service lift onto a refuse vehicle, according to an embodiment.

### DETAILED DESCRIPTION

### Overview

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

In various refuse vehicle systems, it may be desirable to lift or otherwise separate a body of the refuse vehicle from a chassis of the refuse vehicle, which may be located below the body and may support the body. For example, lifting the body of the refuse vehicle relative to the chassis may enhance or otherwise facilitate access to various components beneath the body, as well as components of the refuse vehicle stored and/or supported by the chassis (e.g., between frame rails of the chassis, etc.). To aid in servicing of refuse vehicles, the refuse vehicle may include actuators that move body components of the vehicle to facilitate access the vehicle's internal components. For example, in at least one embodiment, the refuse vehicle may include a service lift that may be used to lift or otherwise separate the body from the chassis. The service lift may be arranged and configured to reduce the required packaging space along the vehicle chassis that would otherwise be required to accommodate the service lift, to thereby increase available space along the chassis for storing and/or mounting components of the refuse vehicle, such as batteries, fuel tanks, accessories, and other vehicle components. Such arrangements can be particularly beneficial for hybrid electric or electrically powered refuse vehicles, which may include additional equipment for power storage, and in which certain components may need to be located alongside the refuse vehicle for ease of operator access.

According to an exemplary embodiment, a service lift design for a refuse vehicle is disclosed that is configured to be disposed in an area of the chassis between or above the frame rails to thereby reduce space claim along the sides of the vehicle. In at least one embodiment, the service lift is specifically configured for use with an electrically powered refuse vehicle. For example, the service lift may include an electric actuator (e.g., a ball screw actuator, an electric pump, etc.) that is configured to be powered by an onboard battery and/or vehicle generator that is also configured to power other vehicle components. The electric actuator may be arranged along the refuse vehicle so as to facilitate access to an onboard vehicle power supply while reducing the number of additional cables and/or length of cable that could otherwise interfere with vehicle operations.

In at least one embodiment, the service lift may be positioned in an area of the vehicle that is hidden from view during normal operations. As an example, the service lift may be arranged to interface with an upper surface of the chassis (such as an upper surface of one or more frame rails forming the chassis). As another example, the service lift may be arranged to interface with a support extending between the frame rails forming the chassis. Such arrangements may not only allow for extra space alongside the chassis, but may also eliminate the need for mounts alongside the chassis to support service lifts and/or actuators for the service lift, thus providing valuable space alongside the chassis for storage of other components of the refuse vehicle. The electrical components of the body may receive power from a power storage and/or generation system supported within an interior of the chassis below the body or along a side of the chassis. The service lift may be disposed between and coupled to the body and the chassis such that the service lift exerts a downward force on an upper surface of the chassis and/or support member above the chassis. Due to a rigid coupling between a portion of the service lift and the body, the service lift may be operable to lift, pivot, or otherwise separate the body away from the chassis. In various exemplary embodiments, at least a portion of the service lift is positioned within a body of the refuse vehicle. For example, the service lift may be positioned within a cavity of the body that may also be occupied by components of a compactor and/or ejector assembly of the refuse vehicle (e.g., a forward portion of the body adjacent to a cab of the vehicle, etc.), therefore optimizing allocation of space on the refuse vehicle.

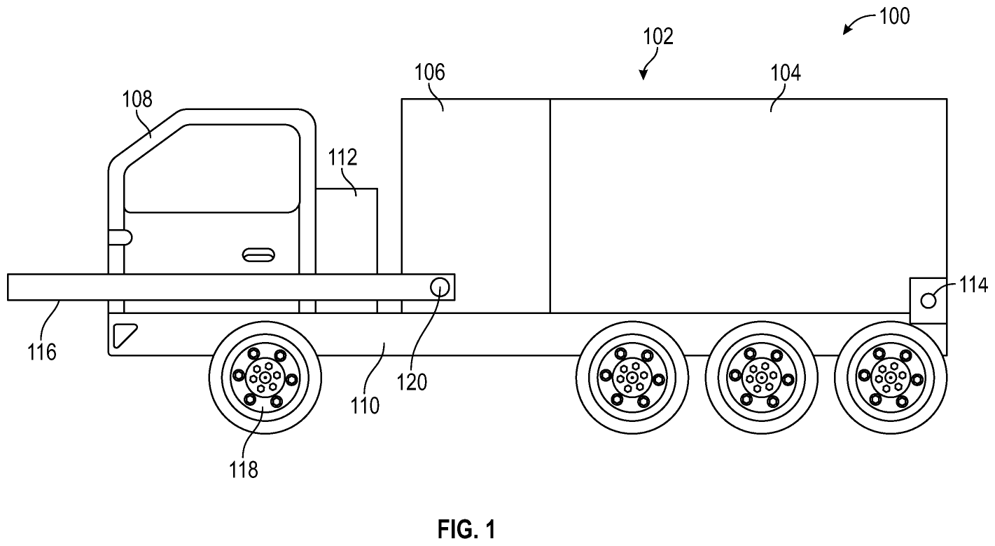

Referring now to FIG. 1, a vehicle is shown as refuse vehicle 100 (e.g., a garbage truck, a waste collection truck, a sanitation truck, a recycling truck, etc.). As shown in FIG. 1, the refuse vehicle 100 includes a chassis, shown as frame 110, a body assembly, shown as body 102, coupled to and/or supported by the frame 110 (e.g., at a rear end thereof, etc.), and a cab, shown as cab 108, coupled to the frame 110 (e.g., at a front end thereof, etc.). The cab 108 may include various components to facilitate operation of the refuse vehicle 100 by an operator (e.g., a seat, a steering wheel, actuator controls, a user interface, switches, buttons, dials, etc.). In some embodiments, the vehicle 100 includes a prime mover, shown as electric motor 112, that is configured to power various components of the electric vehicle. In other embodiments, the prime mover is or includes an internal combustion engine instead of, or in addition to, the electric motor 112. According to the exemplary embodiment shown in FIG. 1, the electric motor 112 is coupled to the frame 110 at a position behind the cab 108 and in front of the body 102. The electric motor 112 is configured to provide power to a plurality of tractive elements, shown as wheels 118 (e.g., via a drive shaft, axles, etc.). In other embodiments, the electric motor 112 is positioned elsewhere along the vehicle 100 and/or the refuse vehicle 100 includes a plurality of electric motors to facilitate independently driving one or more of the wheels 118. In still other embodiments, the electric motor 112 or a secondary electric motor is coupled to a hydraulic system that powers hydraulic actuators and is configured to drive the hydraulic system. In still other embodiments, the electric motor 112 or a secondary electric motor is coupled to, and configured to drive, a pneumatic system that powers pneumatic actuators.

According to an exemplary embodiment, the refuse vehicle 100 is configured to transport refuse from various waste receptacles within a municipality to a storage and/or processing facility (e.g., a landfill, an incineration facility, a recycling facility, etc.). As shown in FIG. 1, the body 102 may include a refuse compartment that includes a collection chamber (e.g., hopper, etc.). Loose refuse may be placed into the body 102 where it may thereafter be compacted (e.g., by a packer system, etc.).

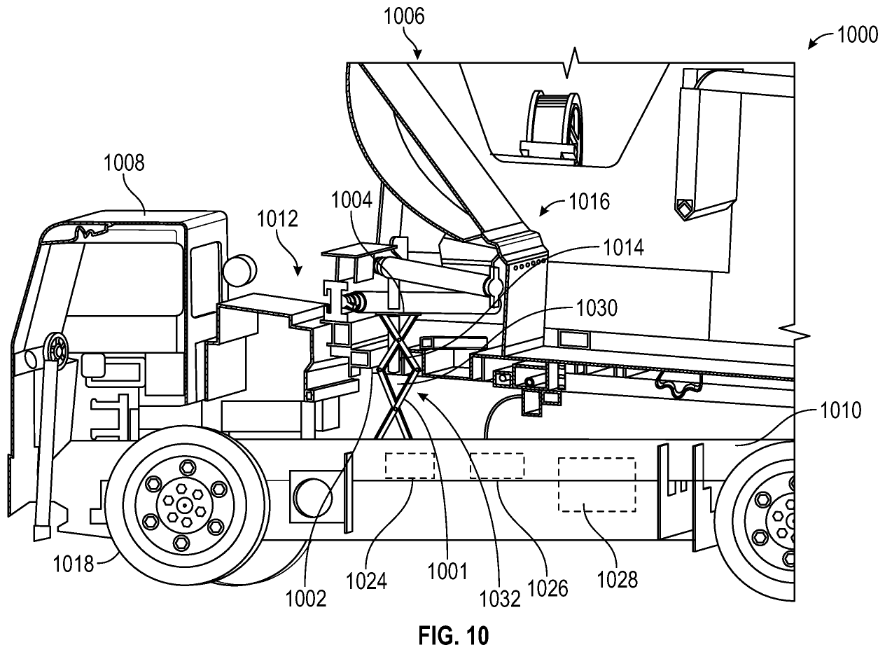

In some embodiments, the body 102 may define a hopper volume 106 and storage volume 104. In this regard, refuse may be initially loaded into the hopper volume 106 and later compacted into the storage volume 104, as depicted in greater detail below with reference to FIG. 10. As shown, the hopper volume 106 is positioned between the storage volume 104 and the cab 108, such that refuse is loaded into a portion of the body 102 behind the cab 108 and stored in a portion toward the back of the body 102. In other embodiments, such as in a rear-loading refuse vehicle, the storage volume 104 may be positioned between the hopper volume 106 and the cab 108. Thus, the body 102 may provide temporary storage for refuse during transport to a waste disposal site and/or a recycling facility. In some embodiments, at least a portion of the body 102 extends above or in front of the cab 108.

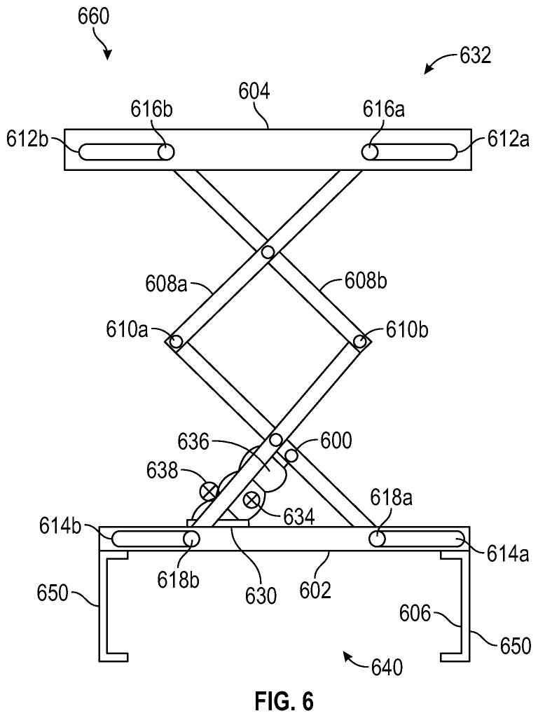

In some embodiments, the frame 110 acts as a storage compartment for one or more vehicle components. The frame 110 may be formed by two or more frame rails (shown in FIG. 6) running the length of the frame 110 and may further include one or more supports extending laterally and/or at an angle between the two or more frame rails.

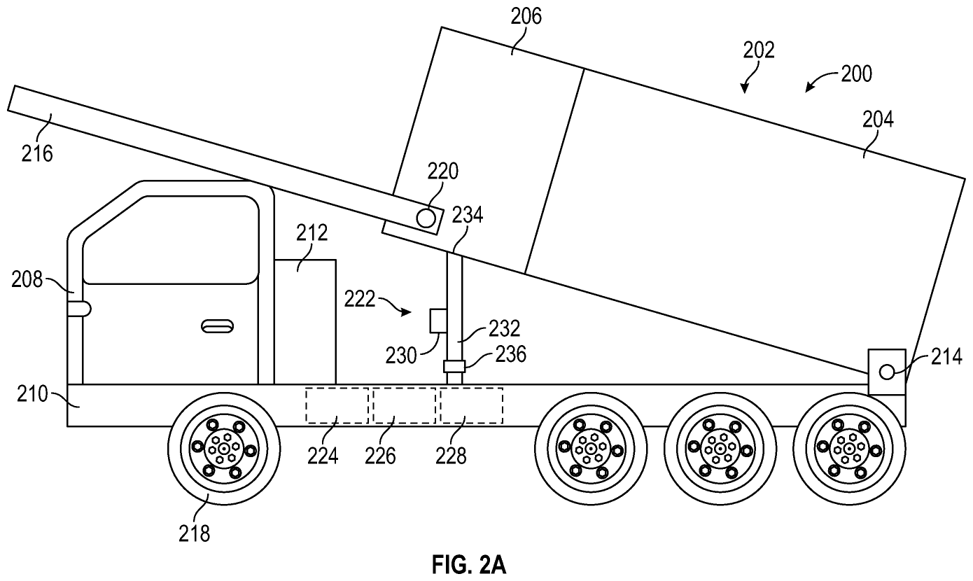

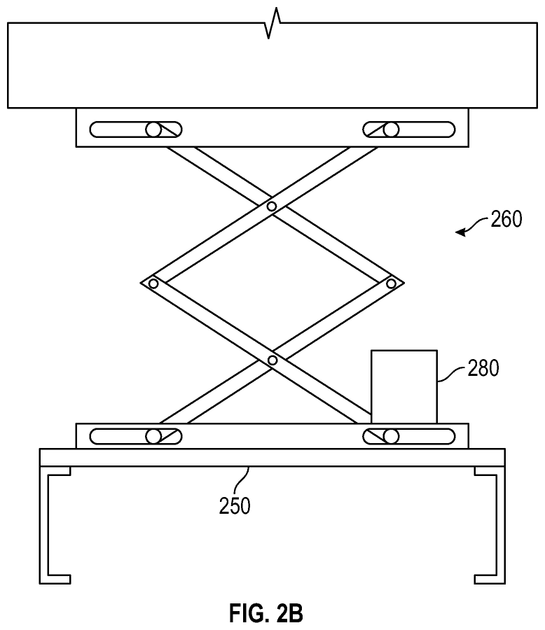

The frame 110 may include an enclosure that contains one or more vehicle components and/or a frame that supports one or more vehicle components. By way of example, the frame 110 may contain or include one or more electrical storage devices (e.g., batteries, capacitors, etc.). By way of another example, the frame 110 may include fuel tanks. By way of another example, the frame 110 may include a hydraulic tank 206 of FIG. 2A, as depicted in greater detail below with reference to FIG. 2A. As discussed in greater detail below, however, the systems and methods described herein may allow for the hydraulic tank 206 to be positioned elsewhere on the vehicle 100, such as on the body 102, or removed entirely from the vehicle 100. By way of another example, the frame 110 may support a pneumatic compressor, as depicted in greater detail below with reference to FIG. 2A. As discussed in greater detail below, however, the systems and methods described herein may allow for the pneumatic compressor to be positioned elsewhere on the vehicle 100, such as on the body 102, or removed entirely from the vehicle 100.

According to an exemplary embodiment, the refuse vehicle 100 includes a torque tube 120 which extends laterally along the body 102 between opposing sides of the body 102. The torque tube 120 pivotally couples an arm 116 (and/or pair of arms, lift arms, etc.) to the body 102, such that the arm 116 is rotatable relative to the body 102 about a lateral axis formed by the torque tube 120. In an exemplary embodiment, arm 116 extends beyond the front of cab 108 so as to be able to engage a refuse receptacle. Pivoting laterally about the torque tube 120, the arm 116 is configured to lift a refuse receptacle (e.g., a refuse container, etc.) that is engaged with the arm 116 and empty the contents of the refuse receptacle into hopper volume 106. In other embodiments, arm 116 is configured to engage alternative receptacles or payloads. For example, in various non-limiting embodiments, arm 116 is configured to engage another vehicle, a person, a rock, dirt, plants, liquids, obstacles, or any other payload.

Referring now to FIG. 2A, the vehicle 200 is shown with the body 202 lifted by at least one service lift assembly 222. In the embodiment of FIG. 2A, the service lift assembly 222 includes a scissor lift 232 and an actuator 230. Further, the vehicle 200 may include an electrical storage and/or generation system 224, a hydraulic tank 226, and a pneumatic compressor 228 coupled to, or supported by, the frame 210. The electrical storage and/or generation system 224 may be configured to provide power to the various electrical components of the vehicle 200, including, but not limited to, the scissor lift 232, electric components of the body 202, and/or the electric motor 212. In some embodiments, the electrical storage and/or generation system 224 is a low-voltage system (e.g., 12 volts). The actuator 230 may be configured to electrically connect to the electrical components of the body 202, such as the electric motor 212 and/or directly to the electrical storage and/or generation system 224 to thereby eliminate the need for separate and/or dedicated motors or power supplies for the service lift assembly 222, and to eliminate the need to run high voltage supply lines in the area of the service lift assembly 222.

The hydraulic tank 226 may be configured to provide fluid to, and receive fluid from (e.g., provide hydraulic power to), various hydraulic components within the refuse vehicle. The pneumatic compressor 228 may be configured to provide gas or pressurized air to, and receive from, various pneumatic components within the refuse vehicle. The pneumatic compressor 228 may be operably coupled to an onboard vehicle power supply, such as the electrical storage and/or generation system 224.

As shown in FIG. 2A, the scissor lift 232 is coupled to and extends between the body 202 and the frame 210. As described in greater detail below, the scissor lift 232 may be positioned within, and extend from, the body 202, and/or may engage an outside wall of the body 202. The scissor lift 232 may be positioned forward of the pivot 214 and rearward of the cab 208. Additionally, the scissor lift 232 may be positioned either rearward or forward of the torque tube 220. In some embodiments, as shown in FIG. 2B the scissor lift 260 and/or actuator 280 may be disposed completely above the frame 250 to thereby free up space for packaging other components between the frame rails. For example, the scissor lift 260 may be mounted to a platform 251 that spaces the scissor lift 232 axially away from the frame rails or that extends across an upper surface of the frame rails. Such an arrangement can also facilitate integration with an onboard electric energy system for the refuse vehicle, and simplify routing of cabling and connections between the actuator 280, scissor lift 260, and onboard power supply.

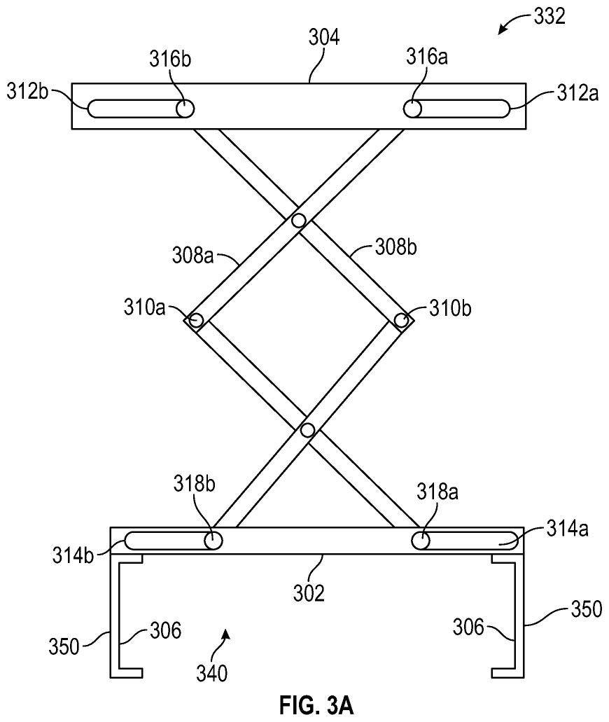

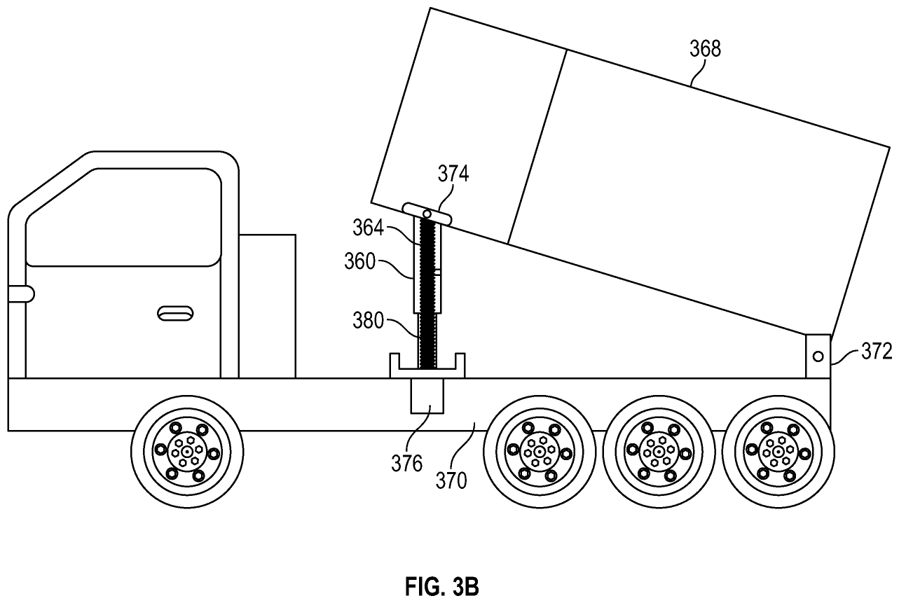

In some embodiments, the scissor lift 232 of FIG. 2A is positioned forward of the pivot 214 and rearward of the torque tube 220. In some embodiments, the scissor lift 232 is positioned beneath the body 202 (e.g., at a central position beneath the body 202). The scissor lift 232 can be used to apply an upward force to lift the body 202 relative to the frame 210 (e.g., when performing maintenance, to tilt or otherwise separate the body 202 from the frame 210). In some embodiments, a range of extension and/or travel of the scissor lift 232 is greater than or equal to approximately 1.5 ft., 2 ft., 2.5 ft., 3 ft., or within a range between and including any two of the proceeding values. Of course, in operation as described in greater detail below, the scissor lift 232 may apply a downward force upon the frame 210 that results in the lifting of the body 202 relative to the frame 210. In some embodiments, an upper portion of the scissor lift 232 is coupled to the body 202 at upper mounting point 234 and a lower portion of the scissor lift 232 is coupled to the frame 210, as depicted in greater detail below with reference to FIG. 3A.

According to an exemplary embodiment, the energy storage and/or generation system 224 is configured to (a) receive, generate, and/or store power and (b) provide electric power to (i) the electric motor 212 to drive the wheels 218, (ii) electric actuators of the refuse vehicle 200 (e.g., located on the body 202 or the frame 210) to facilitate operation thereof (e.g., to power operation of one or more lift actuators, tailgate actuators, packer actuators, grabber actuators, etc.), (iii) the scissor lift 232, and/or (iv) other electrically operated accessories of the refuse vehicle 200 (e.g., displays, lights, etc.). The energy storage and/or generation system 224 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In one embodiment, the refuse vehicle 200 is a completely electric refuse vehicle. In other embodiments, the refuse vehicle 200 includes an internal combustion generator that utilizes one or more fuels (e.g., gasoline, diesel, propane, natural gas, hydrogen, etc.) to generate electricity to charge the energy storage and/or generation system 224, power the electric motor 212, power the electric actuators, and/or power the other electrically operated accessories (e.g., a hybrid refuse vehicle, etc.). For example, the refuse vehicle 200 may have an internal combustion engine augmented by the electric motor 212 to cooperatively provide power to the wheels 218. The energy storage and/or generation system 224 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 200. In some embodiments, the energy storage and/or generation system 224 includes a heat management system (e.g., liquid cooling, heat exchanger, air cooling, etc.).

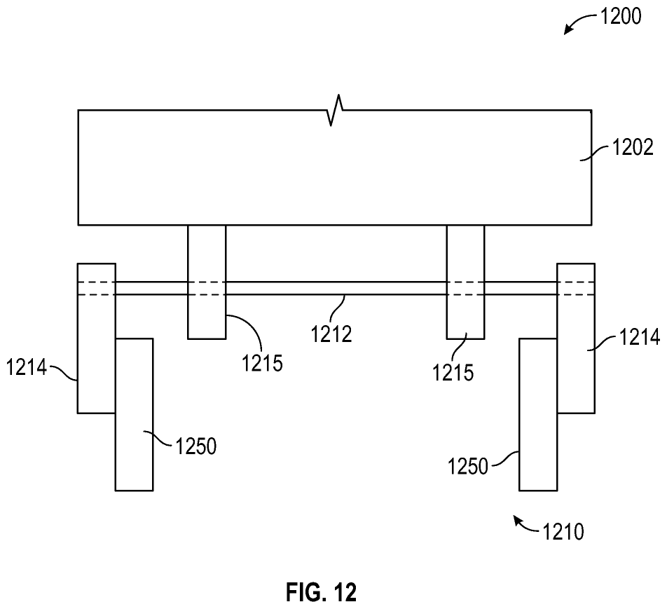

According to an exemplary embodiment, the vehicle 200 includes a bracket(s) (depicted herein as a pivot 214) configured to facilitate rotational movement of the body 202 relative to the frame 210. The pivot 214 pivotally couples the body 202 to the frame 210, such that the body 202 is rotatable relative to the frame 210 about a lateral axis formed by a cross-bar of the pivot 214, as depicted in greater detail below with reference to FIG. 12. The pivot 214 is configured to facilitate movement of the body 202 relative to the frame 210 during operation of the scissor lift 232. In other embodiments, the service lift assembly 222 may be configured to separate the body 202 from the frame 210 along an entire length of the body 202. For example, the service lift assembly 222 may include multiple service lifts spaced apart along a longitudinal direction parallel to the frame rails, or another vehicle configuration.

According to another exemplary embodiment, the service lift assembly 222 is actuated by a source that is external to the vehicle 200, such as a source that operates independently of the prime mover of the vehicle 200 (as described in more detail in FIG. 3A). In such an embodiment, at least one upper mounting point 234 may be used to engage with an external lifting source such as another type of lift, jack, or extension device (e.g., a Hetra lift). In this embodiment, the external lifting source engages with the upper mounting point 234 to lift the body 202 to a raised position relative to the frame 210. This raised position may be pivotally raised about pivot 214. Alternatively, the entire body may be raised from the frame 210. In one embodiment, the upper mounting point 234 is located on the body 202. In another embodiment, the upper mounting point 234 is located on an upper portion of the scissor lift 232. In such embodiments, the scissor lift 232 may be configured as a safety lock to secure the body 202 in position relative to the frame 210 in the event that the external lift fails.

In other embodiments, the upper mounting point 234 may be located either beneath the body 202 or alongside of the body 202, at a plurality of locations along the body 202 (such as at the torque tube 220 and/or the pivot 214) to enable use of a separate service lift assembly “kit” that may be supplied as separate components from the vehicle 200 that are engageable with the upper mounting point 234 to lift the body 202. In such an embodiment, a service lift “kit” may include: (1) a kit with saddle mounting brackets mountable to the body 202 and/or the frame 210, hydraulic cylinders that are engageable with the mounting brackets, and a 12-volt hydraulic pump configured to power movement of the hydraulic cylinders; (2) a kit with only saddle mounting brackets and hydraulic cylinders (without a 12-volt hydraulic pump); (3) a package with only saddle mounting brackets, and (4) a kit with hydraulic cylinders and 12-volt hydraulic pump, where the hydraulic cylinders are engage saddle mounting brackets that are already coupled to the body 202 and/or the frame 210. It should be appreciated that the hydraulic cylinders may be replaced with another type of powered lift in other embodiments, such as an electrically-actuated lift (e.g., a rotary screw, etc.), a rack and pinion configured to facilitate movement of the body 202 relative to the frame 210, etc.

In various non-limiting embodiments, the actuator 230 can be any mechanism that is used to extend the scissor lift from a collapsed first position to a second extended position. In several non-limiting exemplary embodiments, the actuator 230 is an airbag (e.g., air bellow), a screw mechanism, an electric actuator, a rack and pinion gear, or hydraulic lift, etc.

While the service lift assembly 222 is described above as having a scissor lift 232 for exemplary purposes, it should be appreciated that other service lift designs and arrangements may be used without departing from the inventive principles disclosed herein. In one non-limiting embodiment, the service lift assembly 222 is a landing-gear device 360 (e.g., a drop leg jack, etc.) with a lead screw actuator 380 to extend and retract the landing-gear device 360, as depicted in FIG. 3B. In such embodiments, the service lift may include a retractable pad connected to a drop leg that is slidably mounted within a jack sleeve. In some embodiments, the lead screw actuator 380 is an electrically actuated ball screw actuator that is electrically actuated by a rotatable, electrical actuator 376 (e.g., an electric motor). In some embodiments, the electrically actuated ball screw is positioned internal to the landing-gear device 360. In other embodiments, the electrically actuated ball screw is positioned externally to the landing-gear device 360. In some embodiments, the landing-gear device may be similar to a semi-trailer landing gear mechanism. According to some embodiments, the landing gear is fixedly mounted to the upper mounting point 364. As the landing gear extends downward from the body 368, it exerts a downward force on frame 370 through frame rails (frame rails described in greater detail in FIG. 3A). This exerted force results in the body 368 rotating about pivot 372 to raise the body 368 into a lifted position relative to frame 370. In another embodiment, a first end of the landing-gear device may be fixedly coupled to a cross-member and/or support panel extending laterally between the frame rails and may have a second end that is rotatably coupled (e.g., via a pivot, etc.) to a slide element 374 along a bottom wall of the body 368 so as to allow relative rotation between the landing gear device and the body and to maintain the landing gear device in substantially perpendicular orientation relative to the frame rails.

In yet another exemplary embodiment, the service lift assembly 222 of FIG. 2A is a ball screw actuator using a lead screw such as an ACME screw to lift and lower the body 202 relative to frame 210, rotating about pivot 214. In other embodiments, the service lift assembly 222 can be a lead screw mechanism to lift and lower the body 202 relative to the frame 210, rotating about pivot 214. In both screw embodiments, the screw is configured to rotate axially. As the screw rotates axially in a first direction it raises the body 202 relative to the frame 210 about pivot 214.

In embodiments that include a screw actuator, it may be particularly beneficial to the operator of the vehicle 200 to monitor the wear of the screw over time. Monitoring this wear may be accomplished in a variety of methods. For example, an axial anti-backlash nut (comprising a main nut body, a secondary ring, and a spring connecting the main nut body and secondary ring) may be installed with the screw. In such embodiments, a distance between the main nut body and secondary ring may help an operator measure the wear of the screw. Additionally, several other commonly known methods of measuring the wear on a screw may be implemented, such as utilizing an endplate check, monitoring the travel of the nut in relation to the actuation distance of the nut, or using an indicator or other wear monitoring device 236 or apparatus (as opposed to measurements) to monitor the travel. In other embodiments, wear on the ball screw is measured by monitoring energy usage, or using an encoder to measure distance of the backlash of the ball screw. These measurements may be communicated, either manually or automatically, to the operator and/or other personnel through the use of telematics (e.g., via cellular communications, etc.) or any other method of relaying information.

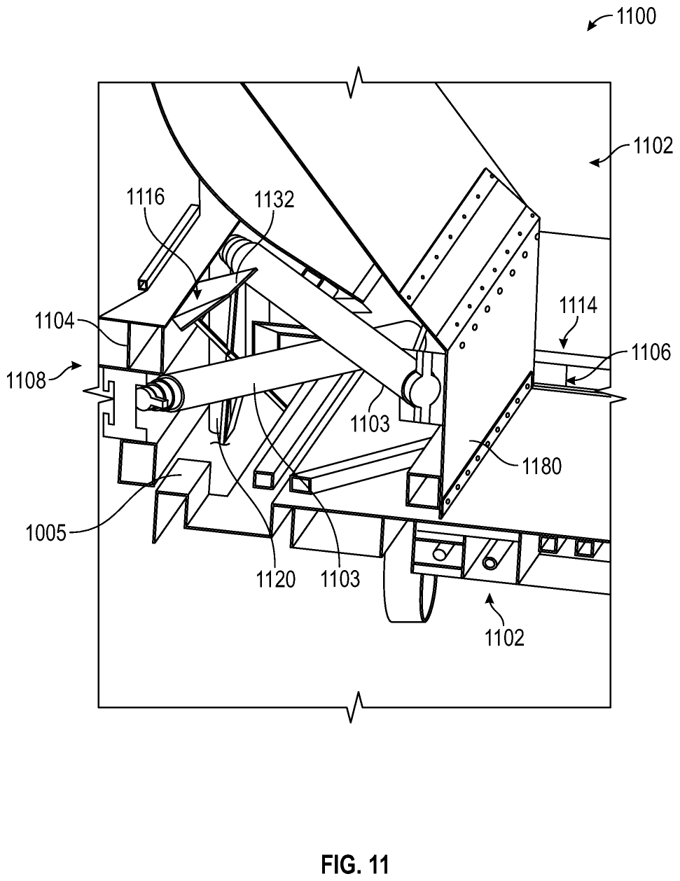

In yet another embodiment, the service lift-assembly may be a laterally actuated wedge that is slidably engaged with the body 202 and/or the frame 210. In this embodiment, the wedge is laterally actuated along the frame 210. In doing so, an upper surface of the wedge engages with the lower surface of the body 202 and/or a surface of a service lift that extends between the chassis and the body (as shown in FIG. 11). With this engagement, the body 202 lifts to a raised position relative to the frame 210, rotating about pivot 214. The laterally actuated wedge may be actuated by various mechanical, electrical, pneumatic, or hydraulic systems, as described in more detail in FIG. 11. In some embodiments, the wedge may be actuated by a packer and/or ejector system. In such embodiments, the wedge may be actuatable between a disengaged position in which movement of the packer/ejector does not cause movement of the wedge to lift the body, and an engaged position in which movement of the packer/ejector causes movement of the wedge to lift the body. For example, the wedge may be pivotally coupled to one or more body components and may be rotated into the engaged position.

Referring now to FIG. 3A, the scissor lift 332 is depicted in the lifted and/or extended position, according to an embodiment. As shown, a scissor lift base 302 (e.g., a first portion, a base, etc.) of the scissor lift 332 engages with, and is coupled to, an upper portion of the frame rails 350 (e.g., an upper surface of the frame rails, a first lateral leg of C-shaped frame rails, etc.). In some embodiments, the scissor lift base 302 engages with, and is coupled to, an interior side 306 portion of the frame rails 350. In other embodiments, the scissor lift 332 is coupled to a support and/or frame member extending laterally and/or at an angle between the frame rails (e.g., a support plate disposed on the upper end of the frame rails and extending between frame rails, etc.). An upper portion 304 (e.g., a second portion, a platform, etc.) of the scissor lift 332 is configured to interface with (e.g., engage, etc.) the body 102 of FIG. 1, according to some embodiments. In some embodiments, the upper portion 304 of the scissor lift 332 interfaces with a lower portion of the body 368. In other embodiments, the upper portion 304 of the scissor lift 332 interfaces (e.g., engages) with a component within the body 368 so that the scissor lift 332 is at least partially disposed within the body 368.

In the embodiment of FIG. 3A, the scissor lift 332 includes a scissor lift base 302, an upper portion 304 of the scissor lift 332, and at least a pair of arms 308a, 308b (e.g., legs, etc.) extending between the scissor lift base 302 and the upper portion 304 of the scissor lift 332. The arms 308a, 308b are hingedly coupled to the scissor lift base 302 through sliding pins 314a, 314b, respectively. The arms 308a, 308b are hingedly coupled to the upper portion 304 of the scissor lift 332 through sliding pins 312a, 312b, respectively. The arms 308a, 308b; the upper portion 304 of the scissor lift 332; the scissor lift base 302; and the upper portion 304 of the scissor lift 332 may be configured (e.g., arranged) in various manners. In some embodiments, the scissor lift base 302 has a planar lower surface to sit securely on the frame rails 350. Alternatively, the scissor lift base 302 may be configured to mount between frame rails 350.

Each arm 308a, 308b has at least one hinged elbow 310a, 310b configured to allow arm 308a, 308b to travel between a raised and/or extended position (FIG. 2A) and a collapsed and/or retracted position (FIG. 1). The arms 308a, 308b may be constructed of any suitable material, such as steel, aluminum, or any other appropriate material and may optionally be “C” shaped. Materials for the arms 308a, 308b may be selected, like the materials for all other aspects of the scissor lift 332, based on desired lifting capacity and/or other application specific requirements.

In some embodiments, the service lift assembly 222 of FIG. 2A may further include a safety lock (e.g., a cam lock, etc.) configured to prevent the scissor lift, such as scissor lift 332 of FIG. 3A, from retracting without disengaging the safety lock. The service lift assembly 222 may be configured to automatically engage the safety lock when the scissor lift 332 (or other embodiment, e.g., landing gear, ball screw, lead screw, etc.) is in the extended position. For example, the actuator 230 may be configured to rotate or otherwise engage the safety lock automatically after fully extending the scissor lift 332 so as to place the scissor lift 332 in a safety position. In this safety position, the scissor lift 332 will remain in the extended position (FIG. 2A) without any input from an actuator. In one exemplary embodiment, the scissor lift 332 has a cam mechanism that engages when the scissor lift 332 is fully extended. The cam mechanism may include a winch cable, a cam lock, or any other form of safety lock, which may be configured to cam over and lock onto itself or another portion of the scissor lift assembly. The scissor lift 332 can release from the safety position by several alternative methods. One exemplary embodiment includes using an actuator to lift, rotate, or otherwise disengage the safety lock by operation of the actuator and thus release the cam mechanism, allowing the scissor lift 332 to release from the safety position. Another safety lock embodiment includes a non-backtracking scissor lift. Yet another safety lock embodiment is a support post that engages when the service lift assembly 222 is in the extended position.

In an exemplary embodiment, the upper portion 304 of the scissor lift 332 extends laterally beyond frame 310 and frame rails 350. In this configuration, a source external to the refuse vehicle 300 may be used to lift the body 368. Sources external to the refuse vehicle 300 that may be used to lift the body include forklifts, jacks, cables and winches, automotive service lifts, etc. In another exemplary embodiment, the scissor lift 332 may be removably connected to the frame 340 and body 368. In this configuration, the scissor lift 332 may be used as an after-market kit to vehicle 300 as described above. Additionally, in this removable configuration, a single kit may be used as a service lift assembly for several vehicles. As described above in FIG. 2A, various embodiments of this kit exist.

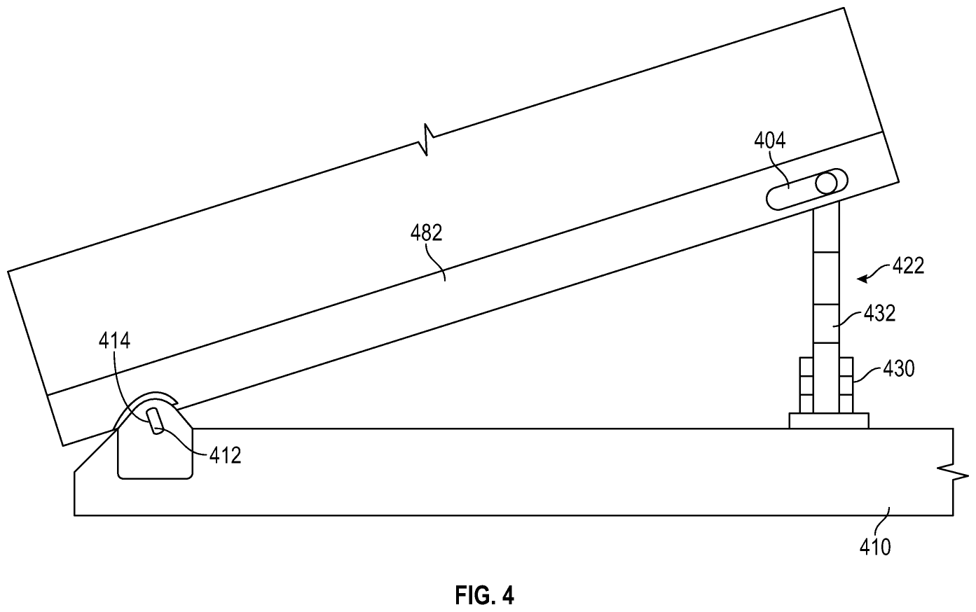

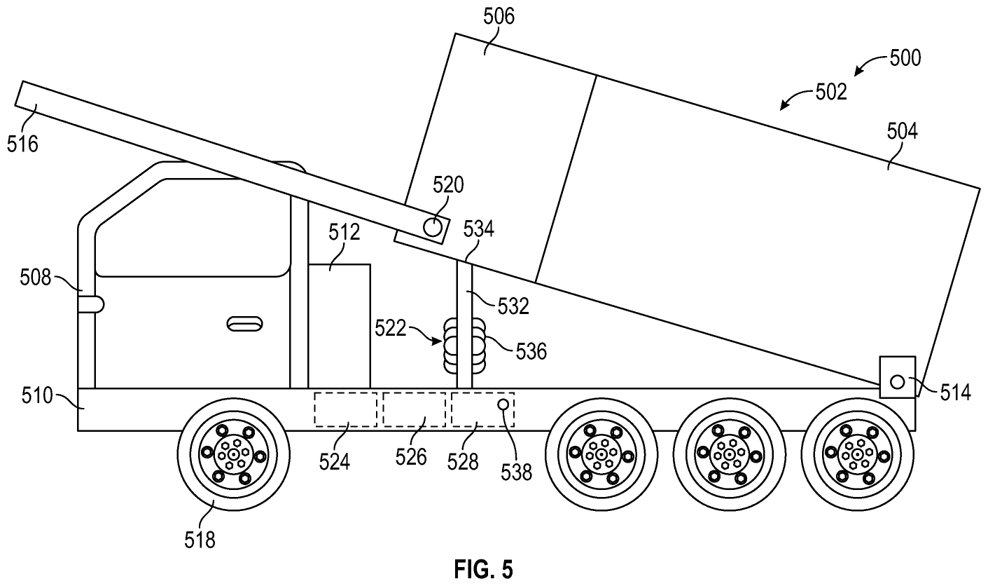

Referring now to FIG. 4, the body 402 is shown lifted by at least one service lift assembly 422, shown as a scissor lift 432 and an actuator 430. In one exemplary embodiment, the actuator 430 is at least one airbag with high weight capacity (e.g., 4000-5000 pound lift capacity), as described in greater detail in FIGS. 5 and 6. The actuator 430 is physically coupled to the scissor lift 432 so as to be used to extend and collapse the scissor lift 432 and thereby raise and lower the body 402. The body 402 is hingedly coupled to the frame 410 by the pivot 414. A crossbar 412 may run laterally between two portions of the pivot 414 (as described in greater detail in FIG. 12) to facilitate the rotatable coupling of the body 402 to the frame 410. Thus, in some embodiments, when the body 402 is lifted relative to the frame 410, a portion of the weight of the body (a portion of the body that is not supported by the scissor lift 432) is supported by the crossbar 412, which in turn is supported by the pivot 414, which in turn are supported by the frame 410 by way of the two frame rails of the frame 410, as shown in greater detail in FIG. 12, which are in turn generally supported by the wheels (the wheels shown in greater detail in FIG. 2A).

In some embodiments, when the body 402 is lifted relative to the frame 410—as shown in FIG. 4—the body 402 is supported by a combination of the crossbar 412 and the scissor lift 432. In an exemplary embodiment, the scissor lift 432 supports the body 402 by way of at least one slot 404 in the body 402. The upper portion of the scissor lift 432 is configured to translate within the slot 404 of the body 402 as the scissor lift 432 extends and collapses so as to allow the scissor lift 432 to remain oriented substantially perpendicular to the frame rails while allowing the body 402 to rotate about pivot 414. The body 402 is supported by the upper portion of the scissor lift 432, which in turn is supported by pins 316a, 316b, which in turn are supported by arms 308a, 308b, which in turn are supported lower pins 318a, 318b, which in turn are supported by the frame 110 by way of the two frame rails 350 of the frame 410, which in turn are generally supported by the wheels 118, according to some embodiments.

Referring now to FIG. 5, a vehicle 500 is shown with the body 502 lifted by at least one service lift assembly 522, shown as a scissor lift 532 and an actuator. In one exemplary embodiment, the actuator is at least one airbag 536, as described in greater detail in FIG. 6. The airbag 536 is physically coupled to the scissor lift 532 so as to be used to extend and collapse the scissor lift 532 and thereby raise and lower the body 502. The airbag 536 is configured to receive gas or pressurized air from a pneumatic compressor 528. Upon receiving the gas or pressurized air from pneumatic compressor 528, the airbag 536 expands from a first deflated state to a second inflated state and actuates the scissor lift 532. In one exemplary embodiment, the airbag 536 inflates with pressurized gas from the pneumatic compressor 528 and applies a force against the scissor lift 532 to extend it. In another exemplary embodiment, the airbag 536 inflates with gas or pressurized air from the pneumatic compressor 528 and applies a force against the scissor lift 532 to collapse it. In one non-limiting embodiment, the airbag 536 is made from impervious materials to protect against contaminants such as a refuse.

In addition to airbag 536 receiving gas or pressurized air from the pneumatic compressor 528, airbag 536 can be configured to receive gas or pressurized air from an external pneumatic compressor or other pressurized gas source, such as an air suspension system of the refuse vehicle. In such embodiments, the service lift assembly includes an air valve 538 that allows a pressurized gas source (e.g., an external pressurized gas source, a gas source onboard the refuse vehicle used to operate other vehicle equipment, etc.) to connect to the airbag 536 to inflate or deflate the airbag 536, for example, in the event of a pneumatic compressor 528 malfunction. Additionally, the external pressurized gas source may be used to inflate or deflate the airbag 536 when the pneumatic compressor 528 is functioning properly. Air valve 538 may be configured to attach to an airtight hose, pipe, or any other means of transporting gas or pressurized air to the service lift actuator.

Referring now to FIG. 6, the scissor lift 632 is shown with at least one airbag 636. In one exemplary embodiment, the airbag 636 is used to extend and collapse the scissor lift 632. The airbag 636 is fixedly coupled to the scissor lift base 602 by lower the airbag mount 630. The airbag 636 is fixedly coupled to the arm 608a by the upper airbag mount 600. In the exemplary embodiment shown in FIG. 6, scissor lift 632 extends as airbag 636 expands as it receives air from pneumatic compressor 528. In other exemplary embodiments, airbag 636 can receive pressurized air or gas from various other sources. These sources can include an external pneumatic compressor, connected to airbag 636 through air valve 634 or an onboard vehicle pneumatic system through air valve 634. The pneumatic compressor 528 and the air valve 634 are both connected to airbag 636 by means of an impermeable and airtight connection so as to allow pressurized air or gas to travel between the airbag 636 and pneumatic compressor 528 via the air valve 634. The air valve 634 is configured to be opened to allow externally sourced pressurized air or gas (or a vehicle pneumatics system) to enter or exit the airbag 636. Alternatively, when the air valve 634 is in a closed position, pressurized air or gas is unable to enter or exit the airbag 636 from or to an external pressurized air or gas source. In another embodiment, air valve 634 is a two-way valve allowing for gas or pressurized air to enter from the pneumatic compressor 528 or an external source. Additionally, this two-way embodiment valve can be closed so as to stop the flow of gas or pressurized air into or out of the airbag 636.

In some embodiments, airbag 636 can include a safety valve 638. Safety valve 638 may be configured to be in an open state, a closed state, or to switch between open and closed states. When the safety valve 638 is in a closed state, gas or pressurized air cannot enter or exit the airbag 636. When the safety valve 638 is in an open state, gas or pressurized air can enter or exit the airbag. In yet another embodiment, safety valve 638 may act as a safety mechanism, whereby the safety valve 638 is in a default closed position and when the airbag reaches a pressurized state that exceeds a safe amount of pressure the safety valve 638 will open to release pressure from within the airbag 636. In some embodiments, air valve 634 and safety valve 638 are the same valve. In other embodiments, air valve 634 and safety valve 638 are separate valves that are independent from one another.

In some embodiments, an upper portion of the airbag 636 mounts to a lower portion of the upper portion 604 of the scissor lift 632. The lower portion of the airbag 636 may be configured to mount to an upper portion of the scissor lift base 602. In such arrangements, the force exerted from the airbag 636 on the body through the upper portion of the scissor lift 632 raises the body relative to the frame 640. In some embodiments, the upper airbag mount 600 is located on an arm 608a of the scissor lift 632. In such embodiments, the airbag 636 inflates to exert a force on the arm 608a to extend the scissor lift into an extended position. In such embodiments, the body 660 is raised relative to the frame 640 by the scissor lift 632.

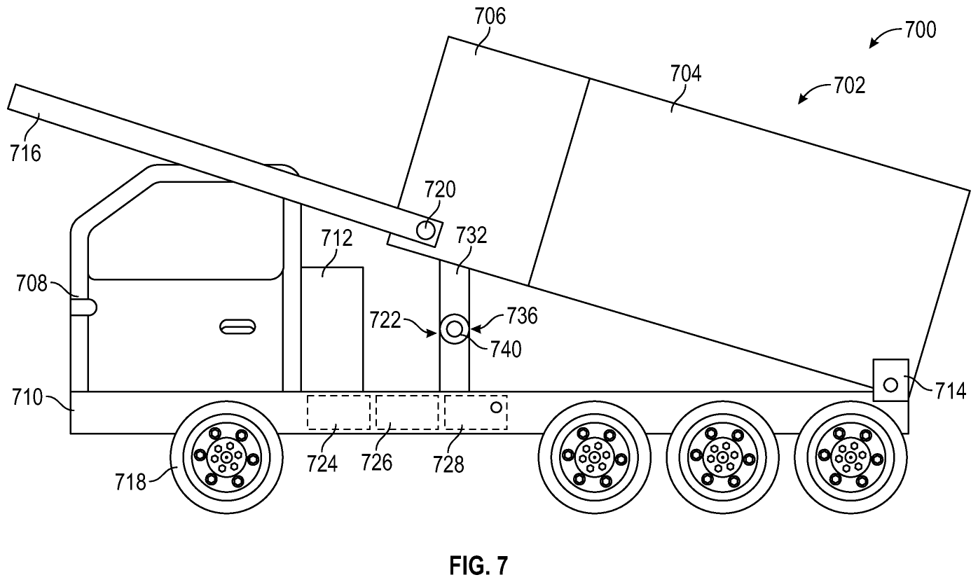

Referring now to FIG. 7, the vehicle 700 is shown with the body 702 lifted by at least one service lift assembly 722, shown as a scissor lift 732 and an actuator. In one exemplary embodiment, the actuator is at least one screw mechanism 736. The screw mechanism 736 is physically coupled to the scissor lift 732 so as to be used to extend and collapse the scissor lift 732 and thereby raise and lower the body 702. The screw mechanism 736 is configured to receive rotational force. In one non-limiting example, the screw mechanism 736 is a lead screw. Upon receiving a rotational force, the screw mechanism 736 is configured to spin and thereby actuate the scissor lift 732. In one exemplary embodiment, the screw mechanism 736 receives a rotational force through the use of gears (e.g., a gearbox, etc.) connecting a prime mover of the refuse vehicle to the screw mechanism 736. In such embodiments, the screw mechanism may be connected to the gearbox and/or electric motor by an electronic power take-off system that is configured to control power supplied to the screw mechanism by the electric motor and/or batteries.

In some embodiments, the prime mover is an electric motor 712. In another exemplary embodiment, the screw mechanism 736 is configured to receive an external rotational force through linkage 740 (e.g., a manual actuator). In one exemplary embodiment, linkage 740 is configured to receive a power drill attachment (e.g., a half-inch drive attachment) thus allowing a power drill to actuate the screw mechanism to extend and collapse it. The screw mechanism 736 can further be configured to receive rotational force through the use of belts and pulleys that connect a gearbox or other actuator coupling to the screw mechanism 736.

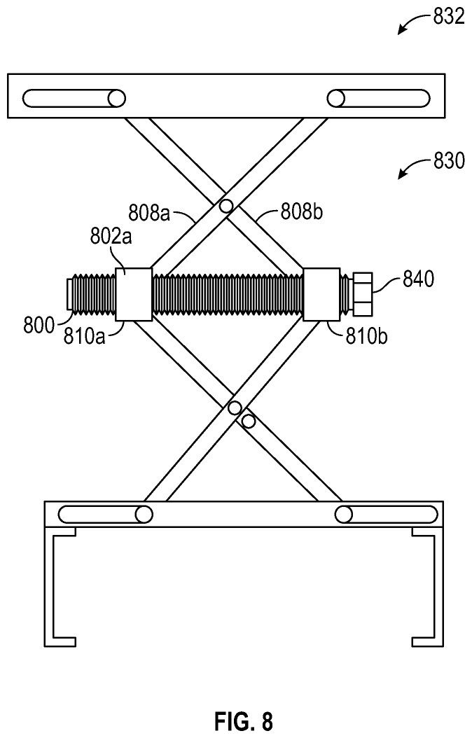

Referring now to FIG. 8, a leadscrew 800 extends through the arms 808a, 808b (e.g., at the elbows 810a, 810b), and any suitable mechanism may be used to turn the leadscrew 800. In some embodiments, a handle is used to turn the leadscrew 800. While not specifically shown, the handle may attach to the leadscrew 800, for example, at linkage 840. It should be appreciated that any appropriate handle, whether now existing or later developed, may be used to turn the leadscrew 800. In another embodiment, a power tool, such as an electric drill, is used to turn the leadscrew 800. In yet another embodiment, a lever is used to turn the leadscrew. In yet another embodiment, the leadscrew 800 is turned by a pulley connected to a rotational member mounted to the vehicle 100. This rotational member may be actuated to rotate by an electric motor, an internal combustion engine, a pneumatic mechanism, or a hydraulic mechanism, according to some embodiments.

The leadscrew 800 is fixedly, though rotatably, attached to the arm 808b (e.g., at elbow 310b). A leadscrew nut 802 is used at the elbow 810a, wherein the threads of the leadscrew 800 are rotatably engaged with the threads of the leadscrew nut 802. The leadscrew 800 is turned in a first direction to move the elbows 810a, 810b next to each other and thus extend the scissor lift 832. The leadscrew 800 is turned in a second direction to move the elbows 310a, 310b farther apart, in doing so, collapsing the scissor lift.

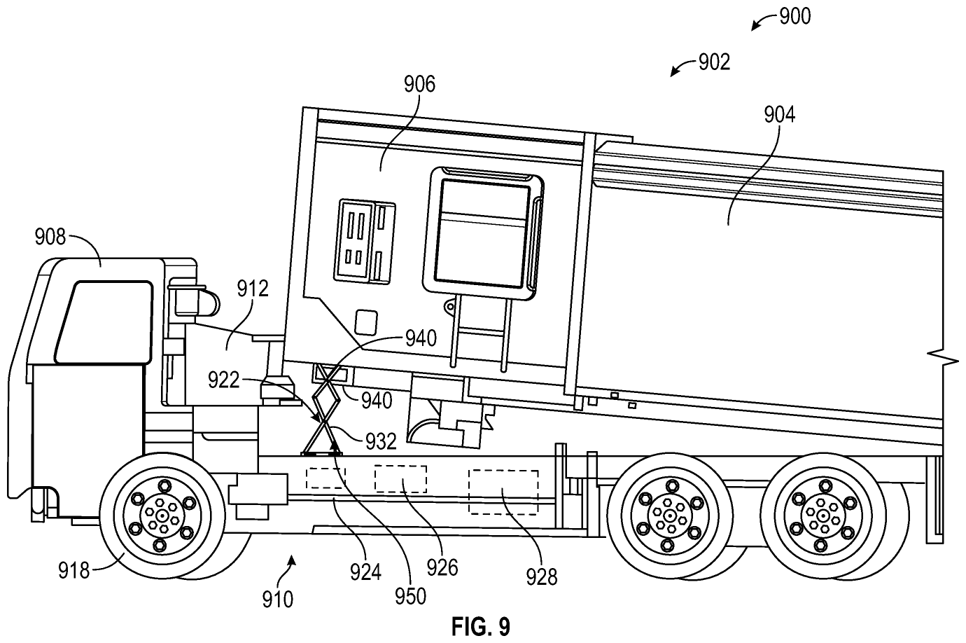

Referring now to FIG. 9, the scissor lift 932 is depicted in a lifted position, according to some embodiments. As shown, the base of the scissor lift 932 interfaces with the upper portion of the frame rails 950. The upper portion of the scissor lift 932 interfaces with the body 902, according to some embodiments. In another embodiment, the upper portion of the scissor lift 932 of the scissor lift interfaces with the interior of the body 902.

The body 902 may be lifted by the scissor lift 932 over the frame 910. The body 902 may be lifted in order to perform maintenance on the vehicle 900. For example, lifting the body 902 may facilitate decoupling power to the vehicle 900 or maintenance of components beneath the body 902 (such as components stored on a lower portion of the body 902), forward of the body 902, and/or on or within the frame 910. As shown, the scissor lift 932 may generally be located within the body 902 in some embodiments. In other embodiments, the lift cylinder may be more specifically located within the hopper volume 906 and extend downward from the hopper volume 906 to interface with the frame 910.

Referring now to FIG. 10, a more detailed depiction of the vehicle 1000 being lifted by the scissor lift 1032 is shown, according to some embodiments. The scissor lift 1032 includes a first end 1001 (e.g., a frame end) coupled to the frame 1010, and a second end 1014 (e.g., a body end) coupled the body 1002. The second end 1014 of the scissor lift 1032 may be coupled to the body 1002 and extend into the hopper volume 1006. The first end 1001 of the scissor lift 1032 is configured to move relative to the second end 1014. The first end 1001 of the scissor lift 1032 is rotatably coupled to an upper surface of the frame 1010 to facilitate the lifting methods disclosed herein. Thus, as suggested above, the second end 1014 may be disposed within the hopper volume 1006 and the first end 1001 may extend downward from the body 1002 to interface with the frame 1010. The first end 1001 may interface with the frame 1010 on an upper surface of the frame 1010 (e.g., an upper surface of either of two frame rails forming the frame 1010, a support extending between the two frame rails forming the frame 1010, etc.). In operation, the scissor lift 1032 extends (e.g., the first end 1001 moves away from the second end 1014) as the body 1002 moves upward relative to the frame 1010. Similarly, the scissor lift 1032 retracts (e.g., the first end 1001 move towards the second end 1014) as the body 1002 moves downward relative to the frame 1010. Thus, in some embodiments, the scissor lift 1032 operates to push down on the frame 1010 in order to lift and/or pivot the body 1002 relative to the frame 1010.

In some embodiments, the first end 1001 extends at least partially into a cavity formed within the body 1002 adjacent to the second end 1014. In particular, the scissor lift 1032 may be coupled to the body 1002 via a lower surface 1030 of the body 1002. The lower surface 1030 may be positioned forward of the hopper volume 1006. The second end 1014 may be disposed within, or rigidly coupled to, the lower surface 1030 and/or the lower surface 1030 may be disposed within the body 1002. When the scissor lift 1032 is operated to extend the first end 1001 away from the second end 1014, the lift cylinder acts to exert a downward force against the frame 1010. Due to the rigid coupling of the scissor lift 1032 to the lower surface 1030 (and thus the body 1002, in general), the body 1002 may be lifted. Accordingly, the scissor lift 1032 can control the relative position of the body 1002 and the frame 1010. As suggested above, such an arrangement of the scissor lift 1032 (e.g., coupled to an upper surface of the frame 1010 and disposed within the hopper volume 1006), can conserve space on the frame 1010 (e.g., on the sides of the frame 1010, within the frame 1010, etc.) as compared to various other systems.

In some embodiments, the scissor lift 1032 is actuated by at least one airbag. By way of example, if a gas (e.g., air) were added to the airbag chamber, the scissor lift 1032 would extend and raise the body 1002. If air were allowed to be released from the airbag chamber, the scissor lift 1032 would retract and lower the body 1002. The provision and removal of gas from the scissor lift 1032 may be facilitated by the pneumatic compressor 1028. Thus, the amount of gas in each scissor lift 1032 may be varied by an operator to raise or lower the body 1002. While the pneumatic compressor 1028 is depicted as coupled to or supported by the frame 1010, positioning the scissor lift 1032 within the body 1002 as shown may allow for repositioning the pneumatic compressor 1028 within the body 1002, in some embodiments. Thus, in some embodiments, the pneumatic compressor 1028 may be removed from the vehicle 1000 entirely. Either repositioning the pneumatic compressor 1028 within the body 1002 or removing the pneumatic compressor 1028 entirely (in embodiments where the scissor lift 1032 is actuated by an electrical actuator) may further provide additional space for other components along the frame 1010. Moreover, in some embodiments, the scissor lift 1032 is actuated by an electric motor powered by the energy storage and/or generation system 1024. By way of example, electrical power supplied to the scissor lift 1032 by the electrical storage and/or generation system 1024 may allow the extend and retract the scissor lift 1032 as described above.

In some embodiments, a compactor, shown as packer system 1016 (e.g., press, compactor, packer, etc.), is positioned within the body 1002. Specifically, the packer system 1016 may be positioned within the hopper volume 1006 and/or a head frame area of the body 1002 between the hopper volume 1006 and a cab of the vehicle. According to an exemplary embodiment, packer system 1016 is configured to compact the refuse within the hopper volume 1006 of the body 1002, thereby increasing the carrying capacity of the vehicle 1000. The packer system 1016 may also be configured to eject stored refuse material from the body 1002. In some embodiments, packer system 1016 utilizes hydraulic power provided by the hydraulic system 1026 to compact and/or eject the refuse from the hopper volume 1006 into/from the storage portion. In other embodiments, the packer system 1016 utilizes electric power supplied, as an example, by the energy storage and/or generation system 1024.

Referring now to FIG. 11, a packer system 1106 is shown in greater detail, according to some embodiments. The packer system 1106 includes a ram, shown as ejector 1180, and actuators, shown as hydraulic cylinders 1103. As shown, the scissor lift 1132 may be generally located within the packer system 1106 and forward of the ejector 1180. Hydraulic cylinders 1103 are coupled to ejector 1180 and a frame member of body 1102, shown as head wall 1104. Head wall 1104 is positioned along the cab 1108 of the vehicle 1100, according to an exemplary embodiment. According to an exemplary embodiment, the head wall 1104 is a lightweight structure coupled to various lower frame members of body 1102. While depicted as generally disposed within the hopper volume 106, the hydraulic cylinders 1103 may alternatively be disposed within a cavity formed below the body 1102 (and/or hopper volume 1114), above the body 1102, or extend from the frame 1110 into the body 1102 to compact the refuse within the hopper volume 1114 as described herein.

As shown, hydraulic cylinders 1103 are positioned to extend ejector 1180 rearward away from head wall 1104. The hydraulic cylinders 1103 may be positioned to form an “X” shape as shown. In some embodiments, hydraulic cylinders 1103 each include a first end coupled to one of the corners formed by the head wall 1104 and a second end coupled to ejector 1180. According to an exemplary embodiment, hydraulic cylinders 1103 extend diagonally such that the first end is coupled to the ejector 1180 at a first lateral side of body 1102 and the second end is coupled to an opposite lateral side of ejector 1180. The first end may be coupled to the ejector 1180 with a first pivoting bracket and the second end may be coupled to the ejector with a second pivoting bracket. According to an alternative embodiment, packer system 1106 includes hydraulic cylinders 1103 that extend longitudinally along a length of body 1102. According to still other embodiments, packer system 1106 includes a single actuator or another device to slide the ejector 1180 within along the body 1102.

In some embodiments, and as shown, the hydraulic cylinders 1103 may be arranged to form a cavity 1120 extending upwardly from the surface 1004 between the head wall 1104 and the hydraulic cylinders 1103. The scissor lift 1132 may be coupled to the surface 1116 such that the scissor lift 1132 is positioned substantially within the cavity 1120 formed by the “X” arrangement of the hydraulic cylinders 1103 near the head wall 1104.

In some embodiments, the hydraulic cylinders 1103 may be used to position a wedge under the body 1102. In forcing the wedge under body 1102, body 1102 is lifted to an elevated position relative to the frame 1110. In this exemplary embodiment, the hydraulic cylinders 1103 are optionally adjusted to be used to exert a force either on the ejector 1180 or the wedge. Alternatively, in other exemplary embodiments, the wedge may be forced under the body using a rack and pinion gear. In one embodiment the rack and pinion gear is actuated by the eject motor using the electrical storage and/or generation system 1024 of FIG. 10. In another exemplary embodiment, the rack and pinion gear is actuated by the chassis low voltage. Alternatively, in another embodiment, the rack and pinion gear is actuated by the pneumatic compressor 1028 of FIG. 10. In another embodiment, the rack and pinion gear is actuated by a hydraulic system 1026 of FIG. 10. In yet another embodiment, the rack and pinion gear is actuated by the vehicle 1100 gearbox.

Referring now to FIG. 12, the pivot 1214 of the vehicle 1200 is shown from a rear perspective of the vehicle 1200. As shown, the frame 1210 includes two separate frame rails 1250 as shown. The body 1202 may also form a pair of separate body rails 1215, as shown. In other embodiments, the body 1202 is a solid member filling the entire cavity depicted between the separate body rails 1215. A crossbar 1212 may run laterally between two portions of the pivot 1214 to facilitate the rotatable coupling of the body 1202 to the frame 1210. Thus, in some embodiments, when the body 1202 is lifted relative to the frame 1210, a portion of the weight of the body 1202 is supported by the crossbar 1212 via the body rails 1215.

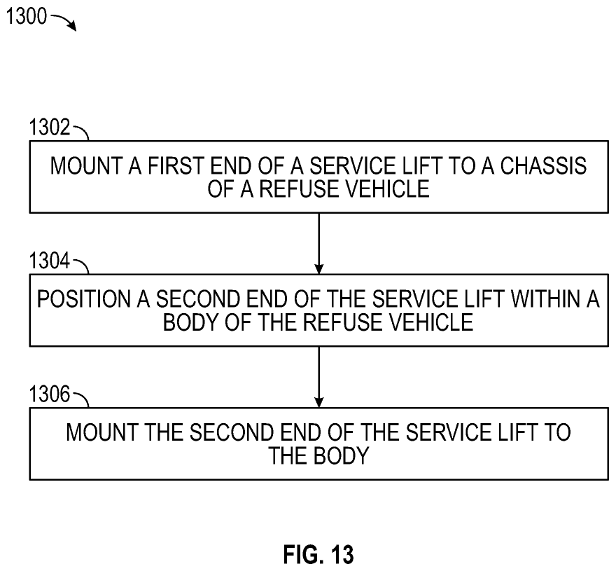

Referring to FIG. 13, a method 1300 of installing a service lift onto a refuse vehicle is shown, such as any of the refuse vehicles described with respect to FIGS. 1-12, according to an embodiment. In other embodiments, the method 1300 may include additional, fewer, and/or different operations.

At 1302, a first end of a service lift is mounted to a chassis of the refuse vehicle. Operation 1302 include mounting the first end to the refuse vehicle so that the first end is disposed laterally between a pair of frame rails of a chassis of the refuse vehicle. In some embodiments, operation 1302 includes positioning the first end (e.g., a mounting plate at the first end, etc.) within a space formed between the pair of frame rails. In some embodiments, operation 1302 includes engaging the first end with a support plate that is mounted to each frame rail of the pair of frame rails. In other embodiments, operation 1302 includes engaging the first end with an upper surface of the pair of frame rails, or with a support plate that extends across an upper surface of each frame rail of the pair of frame rails.

At 1304, a second end of the service lift is positioned within a body of the refuse vehicle that is coupled to the chassis. In some embodiments, operation 1304 includes positioning the second end within a head frame area of the body that is disposed between a cab of the refuse vehicle and a hopper volume defined by the body. For example, operation 1304 may include positioning the second end within a space defined between or adjacent to at least one packer actuator of the body, or between two adjacent packer actuators so that at least a portion of the service lift is centered beneath the body. In some embodiments, operation 1304 includes engaging a portion of the second end with a mounting plate or bracket disposed within the body.

At 1306, the second end is mounted to the body so that the service lift is disposed between the chassis and the body. In some embodiments, operation 1306 includes securing (e.g., fastening, welding, etc.) the second end to a mounting plate or support plate disposed within the body. In other embodiments, operation 1306 includes securing the second end to a lower wall of the body.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (i.e., permanent or fixed) or moveable (i.e., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle, comprising:
a chassis including a pair of frame rails;
a body coupled to the chassis, the body including a lift assembly configured to place refuse material into the body; and
a service lift configured to lift the body away from the chassis, the service lift disposed between the chassis and the body and laterally between the pair of frame rails.

2. The refuse vehicle of claim 1, further comprising a pivot mount pivotally coupling the body to the chassis, such that the body is rotatable from a first position at which the body extends substantially parallel to the chassis and a second position at which the body extends at an angle relative to the chassis and a forward portion of the body is spaced apart from the chassis.

3. The refuse vehicle of claim 1, wherein the service lift comprises a scissor lift.

4. The refuse vehicle of claim 3, wherein the scissor lift comprises:
a lower portion coupled to the chassis;
an upper portion coupled to the body;
a middle portion, comprising at least one scissor linkage; and
an actuator configured to power the scissor lift from a collapsed position in which the lower portion is disposed adjacent the upper portion to an extended position in which the lower portion is spaced apart from the upper portion.

5. The refuse vehicle of claim 1, the body having at least one mounting point that is configured to engage with an external lift for lifting the body away from the chassis.

6. The refuse vehicle of claim 1, wherein at least one end of the service lift is rotatably coupled to at least one of the body or the chassis.

7. The refuse vehicle of claim 1, wherein an end of the service lift extends into the body.

8. The refuse vehicle of claim 1, wherein a first end of the service lift is mounted to the body, and a second end of the service lift is mounted above the pair of frame rails.

9. The refuse vehicle of claim 1, wherein an end of the service lift is mounted in between the pair of frame rails.

10. The refuse vehicle of claim 1, wherein the service lift includes at least one of an airbag, a lead screw, or a rack and pinion.

11. The refuse vehicle of claim 1, wherein the service lift includes at least one electric actuator.

12. A refuse vehicle comprising:
a chassis including a pair of frame rails;
a body coupled to the chassis, the body including a lift assembly configured to place refuse material into the body; and
a service lift configured to lift at least a portion of the body away from the chassis, at least a portion of the service lift disposed within the body.

13. The refuse vehicle of claim 12, further comprising a pivot mount pivotally coupling the body to the chassis, such that the body is rotatable from a first position at which the body extends substantially parallel to the chassis and a second position at which the body extends at an angle relative to the chassis and a forward portion of the body is spaced apart from the chassis.

14. The refuse vehicle of claim 12, wherein the service lift comprises a scissor lift.

15. The refuse vehicle of claim 14, wherein the scissor lift comprises:
a lower portion coupled to the chassis;
an upper portion coupled to the body;
a middle portion, comprising at least one scissor linkage; and
an actuator configured to power the scissor lift from a collapsed position in which the lower portion is disposed adjacent the upper portion to an extended position in which the lower portion is spaced apart from the upper portion.

16. The refuse vehicle of claim 12, wherein a first end of the service lift is mounted to the body, and a second end of the service lift is mounted above the pair of frame rails.

17. The refuse vehicle of claim 12, wherein an end of the service lift is mounted in between the pair of frame rails.

18. A method of installing a service lift onto a refuse vehicle, the method comprising:
mounting a first end of the service lift to a chassis of the refuse vehicle so that the first end is disposed laterally between a pair of frame rails of the chassis; and
mounting a second end of the service lift to a body of the refuse vehicle so that the service lift is disposed between the chassis and the body.

19. The method of claim 18, further comprising positioning the second end of the service lift within the body.

20. The method of claim 18, wherein mounting the first end of the service lift to the chassis comprises positioning the first end within a space formed between the pair of frame rails.
